(19) United States
(12) Patent Application Publication
(10) Pub. No.: US 2011/0206116 A1
(43) Pub. Date: Aug. 25, 2011

(54) METHOD OF PROCESSING A VIDEO SEQUENCE AND ASSOCIATED DEVICE

(75) Inventors: Xavier Henocq, Melesse (FR); Guillaume Laroche, Rennes (FR); Patrice Onno, Rennes (FR)

(73) Assignee: CANON KABUSHIKI KAISHA, Tokyo (JP)

(21) Appl. No.: 13/031,083

(22) Filed: Feb. 18, 2011

(30) Foreign Application Priority Data
Feb. 19, 2010 (FR) 1051228

(51) Int. Cl. H04N 7/32; H04N 7/12

(52) U.S. Cl. 375/240.03; 375/240.12; 375/E07.243; 375/E07.139

(57) ABSTRACT

The present invention concerns a method and a device (10, 20) for processing a video sequence (101) comprising a series of images composed of blocks, et comprising the steps of:
generating (511, 603) a plurality of different reconstructions of at least the same first image (I-1) in the sequence, so as to obtain a respective plurality of reference images (402-413, 517, 518, 610, 611);
predicting (505, 606) a plurality of blocks (Bₖ, 414-416) of the said current image, each from one of said reference images; and
processing jointly, for at least two blocks spatially close in the current image and predicted from the same reference image, prediction information (IPₖ) relating to this reference image.

This application claims priority from French patent application No. 1051228 of Feb. 19, 2010, which is incorporated herein by reference.

### FIELD OF THE INVENTION

The present invention concerns a method and device for processing, in particular for coding or decoding or more generally compressing or decompressing, a video sequence constituted by a series of digital images.

### BACKGROUND OF THE INVENTION

Video compression algorithms, such as those standardized by the standardization organizations ITU, ISO, and SMPTE, exploit the spatial and temporal redundancies of the images in order to generate bitstreams of data of smaller size than those video sequences. Such compressions make the transmission and/or the storage of the video sequences more efficient.

FIGS. 1 and 2 respectively represent the scheme for a conventional video encoder 10 and the scheme for a conventional video decoder 20 in accordance with the video compression standard H.264/MPEG-4 AVC (“Advanced Video Coding”).

The latter is the result of the collaboration between the “Video Coding Expert Group” (VCEG) of the ITU and the “Moving Picture Experts Group” (MPEG) of the ISO, in particular in the form of a publication “Advanced Video Coding for Generic Audiovisual Services” (March 2005).

FIG. 1 schematically represents a scheme for a video encoder 10 of H.264/AVC type or of one of its predecessors.

The original video sequence 101 is a succession of digital images “images i”. As is known per se, a digital image is represented by one or more matrices of which the coefficients represent pixels.

According to the H.264/AVC standard, the images are cut up into “slices”. A “slice” is a part of the image or the whole image. These slices are divided into macroblocks, generally blocks of size 16 pixels×16 pixels, and each macroblock may in turn be divided into different sizes of data blocks 102, for example 4×4, 4×8, 8×4, 8×8, 8×16, 16×8. The macroblock is the coding unit in the H.264 standard.

At the time of video compression, each block of an image in course of being processed is spatially predicted by an “Intra” predictor 103, or temporally by an “Inter” predictor 105. Each predictor is a block of pixels coming from the same image or from another image, on the basis of which a differences block (or “residue”) is deduced. The identification of the predictor block and the coding of the residue enables reduction of the quantity of information actually to be encoded.

In the “Intra” prediction module 103, the current block is predicted using an “Intra” predictor block, that is to say a block which is constructed from information already encoded from the current image.

As for the “Inter” coding, a motion estimation 104 between the current block and reference images 116 is performed in order to identify, in one of those reference images, a block of pixels to use it as a predictor of that current block. The reference images used are constituted by images of the video sequence which have already been coded then reconstructed (by decoding).

Generally, the motion estimation 104 is a “block matching algorithm” (BMA).

The predictor obtained by this algorithm is then subtracted from the current block of data to process so as to obtain a differences block (block residue). This step is called “motion compensation” 105 in the conventional compression algorithms.

These two types of coding thus provide several texture residues (difference between the current block and the predictor block) which are compared in a module 106 for selecting the best coding mode for the purposes of determining the one that optimizes a rate-distortion criterion.

If the “Intra” coding is selected, an item of information enabling the “Intra” predictor used to be described is coded (109) before being inserted into the bitstream 110.

If the module for selecting the best coding mode 106 chooses the “Inter” coding, an item of motion information is coded (109) and inserted into the bitstream 110. This item of motion information is in particular composed of a motion vector (indicating the position of the predictor block in the reference image relative to the position of the block to predict) and of an image index from among the reference images.

The residue selected by the choosing module 106 is then transformed (107) using a DCT (“Discrete Cosine Transform”), and then quantized (108). The coefficients of the quantized transformed residue are then coded using entropy or arithmetic coding (109) and then inserted into the compressed bitstream 110 in the useful data coding the blocks of the image.

Below, reference will essentially be made to entropy coding. However, the person skilled in the art is capable of replacing it by arithmetic coding or any other suitable coding.

In order to calculate the “Intra” predictors or to perform the motion estimation for the “Inter” predictors, the encoder performs decoding of the blocks already encoded using a so-called “decoding” loop (111, 112, 113, 114, 115, 116) to obtain reference images. This decoding loop enables the blocks and the images to be reconstructed on the basis of the quantized transformed residues.

It ensures that the coder and the decoder use the same reference images.

Thus, the quantized transformed residue is dequantized (111) by application of a quantization operation that is inverse to that provided at step 108, then reconstructed (112) by application of the transform that is inverse to that of step 107.

If the residue comes from “Intra” coding 103, the “Intra” predictor used is added to that residue (113) to retrieve a reconstructed block corresponding to the original block modified by the losses resulting from the quantization operation.

If, on the other hand, the residue comes from “Inter” coding 105, the block pointed to by the current motion vector (this block belonging to the reference image 116 referred to by the current image index) is added to that decoded residue (114). The original block is thus obtained modified by the losses resulting from the quantization operations.

In order to attenuate, within the same image, the block effects created by a strong quantization of the residues obtained, the encoder integrates a “deblocking” filter 115, the object of which is to eliminate those block effects, in particular the artificial high frequencies introduced at the boundaries between blocks. The deblocking filter 115 enables the boundaries between the blocks to be smoothed in order to visually attenuate those high frequencies created by the coding. As such a filter is known from the art, it will not be described in more detail here.

The filter 115 is thus applied to an image when all the blocks of pixels of that image have been decoded.

The filtered images, also termed reconstructed images, are then stored as reference images 116 to enable the later “Inter” predictions taking place on compression of the following images of the current video sequence.

For the following part of the explanations, “conventional” will be used to refer to the information resulting from that decoding loop implemented in the state of the art, that is to say in particular by inversing the quantization and the transform with conventional parameters. Henceforth reference will be made to “conventional reconstructed image”.

In the context of the H.264 standard, it is possible to use several reference images 116 for the motion compensation and estimation of the current image, with a maximum of 32 reference images.

In other words, the motion estimation is carried out over N images. Thus, the best “Inter” predictor of the current block, for the motion compensation, is selected in one of the multiple reference images. Consequently, two neighboring blocks may have two predictor blocks which come from two separate reference images. This is in particular the reason why, in the useful data of the compressed bitstream, with regard to each block of the coded image (in fact the corresponding residue), the index of the reference image used for the predictor block is indicated (in addition to the motion vector).

FIG. 3 illustrates this motion compensation using a plurality of reference images. In this Figure, the image 301 represents the current image in course of coding corresponding to the image i of the video sequence.

The images 302 to 307 correspond to the images i-1 to i-n which were previously encoded then decoded (that is to say reconstructed) from the compressed video sequence 110.

In the illustrated example, three reference images 302, 303 and 304 are used in the Inter prediction of blocks of the image 301. To make the graphical representation legible, only a few blocks of the current image 301 have been represented, and no Intra prediction has been illustrated here.

In particular, for the block 308, an Inter predictor 311 belonging to the reference image 303 is selected. The blocks 309 and 310 are respectively predicted by the block 312 of the reference image 302 and the block 313 of the reference image 304. For each of these blocks, a motion vector (314, 315, 316) is coded and transmitted with the reference image index (314, 315, 316).

The use of multiple reference images _ the recommendation of the aforementioned VCEG group may however be noted recommending to limit the number of reference images to four _ is both an error resilience tool and a tool for improving the compression efficiency.

This is because, with a suitable selection of the reference images for each of the blocks of a current image, it is possible to limit the effect of the loss of a reference image or of a part of a reference image.

In the same way, if the selection of the best reference image is estimated block by block with a minimum rate-distortion criterion, this use of several reference images makes it possible to obtain significant savings relative to the use of a single reference image.

However, to obtain these improvements, it is necessary to perform a motion estimation for each of the reference images, which increases the calculating complexity for a video coder.

Furthermore, the set of reference images needs to be kept in memory, increasing the memory space required in the encoder.

Thus, the complexity of calculation and of memory, required for the use of several reference images according to the H.264 standard, may prove to be incompatible with certain video equipment or applications of which the capacities for calculation and for memory are limited. This is the case, for example, for mobile telephones, stills cameras or digital video cameras.

FIG. 2 represents an overall scheme for a video decoder 20 of H.264/AVC type. The decoder 20 receives a bitstream 201 as input corresponding to a video sequence 110 compressed by an encoder of H.264/AVC type, such as that of FIG. 1.

During the decoding process, the bitstream 201 is first of all decoded entropically (202), which enables each coded residue to be processed.

The residue of the current block is dequantized (203) using the inverse quantization to that provided at 108, then reconstructed (204) using the inverse transform to that provided at 107.

The decoding of the data of the video sequence is then carried out image by image, and within an image, block by block.

The “Inter” or “Intra” coding mode of the current block is extracted from the bitstream 201 and decoded entropically.

If the coding of the current block is of the “Intra” type, the index of the prediction direction is extracted from the bit stream and decoded entropically.

The pixels of the decoded neighboring or adjacent blocks that are the closest to the current block according to this prediction direction are used for regenerating the “Intra” predictor block.

The residue associated with the current block is retrieved from the bitstream 201 then decoded entropically. Lastly, the retrieved Intra predictor block is added to the residue thus quantized and reconstructed in the Intra prediction module (205) to obtain the decoded block.

If the coding mode of the current block indicates that this block is of “Inter” type, then the motion information, and possibly the identifier of the reference image used, are extracted from the bitstream 201 and decoded (202).

This motion information is used in the motion compensation module 206 to determine the “Inter” predictor block contained in the reference images 208 of the decoder 20. In similar manner to the encoder, these reference images 208 are composed of images preceding the image in course of decoding and which are reconstructed on the basis of the bitstream (thus previously decoded).

The residue associated with the current block is, here too, retrieved from the bitstream 201 and then decoded entropically. The determined Inter predictor block is then added to the residue thus dequantized and reconstructed, in the inverse motion compensation module 206 to obtain the decoded block.

At the end of the decoding of all the blocks of the current image, the same deblocking filter 207 as that (115) provided at the encoder is used to eliminate the block effects so as to obtain the reference images 208.

The images thus decoded constitute the video signal 209 output from the decoder, which may then be displayed and exploited.

These decoding operations are similar to the decoding loop of the coder. In this report, the illustration of FIG. 3 also applies to the decoding.

In a way that mirrors the coding, the decoder in accordance with the H.264 standard requires the use of several reference images.

Generally, the H.264 coding is not optimal, due to the fact that the majority of the blocks is predicted in reference to a single reference image (the temporally preceding image) and that, due to the use of several reference images, an identification of the latter (use of several bits) is necessary for each of the blocks.

The present invention aims to remedy these inconveniences by proposing a solution to enlarge, at less cost, the spectrum of useable reference images by simplifying the signalling of the latter in the resulting stream.

### SUMMARY OF THE INVENTION

In this context, the present invention concerns in particular a method for processing a video sequence composed of a series of digital images comprising a current image to be processed, said images comprising blocks of data. The method comprises the steps of:
generating a plurality of reconstructions of at least the same initial image in the sequence that are different from each other, so as to obtain a respective plurality of reference images;
predicting a plurality of blocks of said current image, each from one of said reference images; and
processing jointly, for at least two blocks spatially close in the current image and predicted from the same reference image, prediction information relative to this reference image.

For the present invention, the term “spatially close” signifies in particular that the intended blocks are either adjacent, or separated by a small number of blocks which are predicted temporally using the same reconstruction (as the intended blocks) or are not predicted temporally. In other words, spatially close blocks are separated by blocks which are not predicted temporally on the basis of another reconstruction than that used by the intended blocks.

Firstly, the invention enables reference images to be obtained resulting from several different reconstructions of one or several images in the video sequence, generally from among those which have been encoded/decoded before the current image to be processed and in particular the temporally preceding image (see in this sense FIG. 4).

Just as for the H.264 standard, this enables the use of a high number of reference images, with however better versions of the reference images than those conventionally used. A better compression thus results thereby than by using a single reference image per image already coded.

Furthermore, this aspect contributes to reducing the memory space necessary for the storage of the same number of reference images at the encoder or decoder. This is because, a single reference image (generally the one reconstructed in accordance with the techniques known from the state of the art) may be stored and, by producing, on the fly, the other reference images corresponding to the same image of the video sequence (the second reconstructions), several reference images are obtained for a minimum occupied memory space. The calculation complexity to generate the reference images is therefore reduced.

Moreover, it has been possible to observe that, for numerous sequences, the use, according to the invention, of reference images reconstructed from the same image proves to be more efficient than the use of the “conventional” multiple reference images as in H.264, which are encoded/decoded images taken at different temporal offsets relative to the image to process in the video sequence. This results in a reduction in the entropy of the “Inter” texture residues and/or in the quality of the “Inter” predictor blocks.

Secondly, the joint processing of the prediction information relative to a reference image, when the latter has been used for predicting several spatially close blocks, reduces the amount of information to be signalled in the bit stream coding the sequence so as to notify the reference image used for these blocks. An example of joint processing thus consists of coding simultaneously prediction information used for several blocks.

It has indeed been observed that, in H.264, the indication, for each coded block, of the reference image used is often repeated for spatially close blocks, due in particular to the fact that a strong spatial correlation exists between these close blocks. Based on this finding, the inventors have thus provided for the joint processing of these close blocks so as to reduce the amount of information necessary for this indication.

The invention thus presents the following advantages:
a larger number of versions reconstructed from the same image, in particular from the one temporally preceding the image to be processed, can be used in order to improve the prediction and hence the compression of the image blocks, and
joint processing of the information relative to this prediction limits the signalling of the latter, so as to improve the compression.

In one embodiment, the prediction information is coded into or decoded from a portion of bit stream which precedes a following portion comprising useful data coding the set of the blocks of the current image. This arrangement allows serialization of the operations relative to identification of the reference images respectively used when predicting the image blocks with the insertion of the useful data representing the coding information for these blocks. The coder and decoder are thus more efficient.

In particular no identification of said reference images is inserted into said following portion of useful data. Thus, contrary to H.264, the useful data for each coded block is devoid of identification of the reference images. Combined with the joint processing of the prediction information for different spatially close blocks, this arrangement provides a significant improvement to the video sequence compression.

In one embodiment, the method comprises forming a tree structure representing a subdivision of the current image into spatial zones, each spatial zone only comprising blocks which, when they are predicted temporally, are predicted from the same reference image, and the tree structure comprises, associated with each spatial zone thus defined, the prediction information relative to this reference image used. Here, the blocks of the same spatial zone are spatially close blocks in the meaning of the invention.

This tree structure amalgamates into one single structure the whole of the prediction information for the entire image, and thus facilitates the joint processing for several spatially close blocks, grouped here under one spatial zone.

In particular, the tree structure is a “quadtree” representing a recursive subdivision of the current image into quadrants and sub-quadrants corresponding to said spatial zones. The quadtree is particularly well suited to partitioning a two-dimensional space (the image) into sub-sets in a binary system.

According to a particular characteristic, an index is associated to each reconstruction of the first image, and the quadtree comprises leaves each of which corresponds to a spatial zone in the final subdivision, and each leaf is associated to the index corresponding to the reconstruction producing the reference image used in the predictions of the blocks of said spatial zone. Memorisation of the prediction information for each spatial zone is thus made easy for any coder or decoder in the video sequence.

According to another particular characteristic, the tree structure is included in a bit stream portion corresponding to said coded current image, said portion comprising three sub-portions:
a first sub-portion corresponding to the tree structure of the quadtree representing the subdivision of the current image;
a second sub-portion comprising said prediction information relating to all the reference images used for predicting the blocks of the current image; and
a third sub-portion indicating, possibly in the order of the spatial zones resulting from the tree structure set in the first sub-portion, the location, in the second sub-portion, of the prediction information relating to the reference image used for each spatial zone.

The bit stream structure thus offers compactness in particular by virtue of the option of pointing, for different spatial zones, to the same prediction information. Thus, it can be provided that the third sub-portion comprises at least two indications which are relative to two distinct spatial zones and which indicate the same prediction information location in said second sub-portion.

In particular, the first sub-portion corresponds to the tree structure of the quadtree according to a scan in the order of increasing subdivision levels. In particular, the scan order for a given subdivision level is from left to right then from top to bottom, and when a (sub)-quadrant does not exist in a given subdivision level (in particular because it is itself subdivided), the following quadrant is passed to.

In one invention embodiment, the current image is subdivided into spatial zones, each spatial zone comprising solely blocks which, when temporally predicted, are predicted from the same reference image, and the method comprises a step for grouping a plurality of spatial zones corresponding to at least two different reference images in a single spatial zone corresponding to a single reference image.

In particular, said grouping comprises a step for modifying of the temporal prediction of the temporally predicted blocks that initially constitute one of the grouped spatial zones, so that these blocks are temporally predicted from said single reference image.

The implementation of zone groupings reduces the amount of data signalling the prediction information for the entirety of the image. A better compression of the latter can consequently be obtained.

In particular, said grouping is operated when a proportion of the grouped spatial zones greater than a threshold value is associated with said single reference image used. It will be understood in practice that this proportion allows for the spatial extent of these zones relatively to the final zone obtained after grouping: for example 75% of the surface of the latter is initially associated with the same single reference image.

According to a characteristic of the invention, the plurality of reconstructions of the at least one same first image is generated using a respective plurality of different reconstruction parameters, and the prediction information relating to a reference image comprises the reconstruction parameters corresponding to this reference image. Thus, the whole of the information relative to a spatial zone is thus coded in a grouped manner. This simultaneously simplifies the processings at the coder to produce a coded stream, and at the decoder to decode the video sequence.

In particular, said reconstructions comprise an inverse quantization operation on coefficient blocks, and the reconstruction parameters comprise a number of block coefficients modified in relation to a reference reconstruction, an index of each modified block coefficient and a quantization offset associated with each modified block coefficient. These elements allow the decoder to perform limited calculations to pass from the reference reconstruction (generally the “conventional” reconstruction) to the reconstruction applied to the blocks in the spatial zone considered. These calculations may in particular be limited to the predictor blocks used.

According to another characteristic of the invention, the blocks of the current image are only predicted in reference to reconstructions of a single first image, and the prediction information is devoid of identification information for identifying the single first image. The single first image is in particular the image immediately preceding the current image.

In effect, by operating a convention according to which the multiple reconstructions are reconstructions of this single first image, it is no longer necessary to indicate to the decoder the image in the sequence to which the reference images refer as this is stipulated by the convention. The sequence compression is therefore improved.

The invention likewise relates to a processing device, a coder or decoder for example, of a video sequence composed of a series of digital images comprising a current image to be processed, said images comprising blocks of data. The device comprises in particular:
a generation means capable of generating a plurality of different reconstructions of at least the same first image in the sequence, in order to obtain a respective plurality of reference images;
a prediction means capable of predicting a plurality of blocks of the current image, each of them from one of the reference images; and
a processing means to jointly process, for at least two spatially close blocks in the current image and predicted from the same reference image, prediction information relating to this reference image.

The processing device offers similar advantages to those for the processing method stated above, in particular allowing a reduced use of the memory resources, performing calculations of lesser complexity, improving the Inter predictors used during the motion compensation or, moreover, improving the rate/distortion criterion.

Optionally, the device may comprise means referring to the above-mentioned method characteristics.

In particular, the said processing device comprises a quadtree representing a recursive subdivision of the current image into quadrants and sub-quadrants, each quadrant or sub-quadrant comprising solely spatially close blocks which, when they are temporally predicted, are predicted from the same reference image, and

the quadtree comprises, associated to each quadrant and sub-quadrant, the prediction information relating to this reference image used.

When the current image is subdivided into spatial zones, each spatial zone comprising temporally predicted blocks from the same reference image, the processing device may likewise comprise means for grouping a plurality of spatial zones corresponding to at least two different reference images in a single spatial zone corresponding to a single reference image.

The invention likewise concerns a data structure coding a video sequence composed of a series of digital images, the structure comprising:
useful data corresponding to data coding blocks of a first image by prediction from reference images, several reference images corresponding to several reconstructions of the same other image, and
a tree structure representing a subdivision of said first image into spatial zones each grouping one or several spatially close blocks in the first image and predicted from the same reference image; and

wherein the tree structure associates, to each spatial zone, prediction information relating to this same reference image, for example parameters relating to the reconstruction generating this reference image.

This data structure offers advantages similar to those for the above-mentioned method and processing device.

Optionally the data structure may comprise elements referring to the characteristics of the above-mentioned method.

In particular, in this data structure, the tree structure is a quadtree representing a recursive subdivision of an image into quadrants and sub-quadrants corresponding to said spatial zones, whose leaves are associated with the prediction information.

Furthermore, the data structure comprises, within a bit stream, a plurality of frames each corresponding to an image of a video sequence, each frame comprising successively a first header portion comprising the tree structure associated with the image corresponding to the frame and a second portion comprising the useful data associated with said image.

In particular, the first portion comprises:
a first sub-portion corresponding to the tree structure of the quadtree representing the subdivision of the current image;
a second sub-portion comprising the prediction information relating to all the reference images used for predicting the blocks of the image; and
a third sub-portion indicating, possibly in the order of the spatial zones resulting from the tree structure set in the first sub-portion, the location, in the second sub-portion, of the prediction information relating to the reference image used for each spatial zone.

The invention also concerns an information storage means, possibly totally or partially removable, that is readable by a computer system, comprising instructions for a computer program configured to implement the processing method in accordance with the invention when that program is loaded and executed by the computer system.

The invention also concerns a computer program readable by a microprocessor, comprising portions of software code configured to implement the processing method in accordance with the invention, when it is loaded and executed by the microprocessor.

The information storage means and computer program have features and advantages that are analogous to the methods they implement.

### BRIEF DESCRIPTION OF THE DRAWINGS

Still other particularities and advantages of the invention will appear in the following description, illustrated by the accompanying drawings, in which:

FIG. 1 shows the general scheme of a video encoder of the state of the art.

FIG. 2 shows the general scheme of a video decoder of the state of the art.

FIG. 3 illustrates the principle of the motion compensation of a video coder according to the state of the art;

FIG. 4 illustrates the principle of the motion compensation of a coder including, as reference images, multiple reconstructions of at least one same image;

FIG. 5 represents the general scheme of a video encoder according to an embodiment of the invention;

FIG. 6 represents the general scheme of a video decoder according to this same embodiment of the invention;

FIG. 7 shows a structural example of a bit stream according to the invention;

FIG. 8 illustrates an example for indentifying coefficients within a DCT block;

FIG. 9 shows, in the form of a flowchart, steps to generate a part of the bit stream in FIG. 7;

FIG. 10 shows, in the form of a flowchart, steps to construct a quadtree from the steps in FIG. 9;

FIG. 11 shows a subdivision of a current image into quadrants and sub-quadrants, along with the corresponding representation of prediction information and quadtree according to the invention;

FIG. 12 shows the frame header of the structure in FIG. 7, for the example in FIG. 11;

FIGS. 13 and 13a illustrate the grouping of spatial zones according to the invention;

FIG. 14 shows, in the form of a flowchart, decoding steps of a portion of the header of FIG. 7; and configured to implement the method or methods according to the invention.

### DETAILED DESCRIPTION OF EMBODIMENTS OF THE INVENTION

According to the invention, the method of processing a video sequence of images comprises generating two or more different reconstructions of at least one same image that precedes the image to process (to code or decode) in the video sequence, so as to obtain at least two reference images for the motion compensation.

The processing operations on the video sequence may be of a different nature, including in particular video compression algorithms. In particular, the video sequence may be subjected to coding for the purpose of transmission or storage.

For the following part of the description, consideration will more particularly be given to processing of motion compensation type applied to an image of the sequence, in the context of video compression. However, the invention could be applied to other processing operations, for example to motion estimation on sequence analysis.

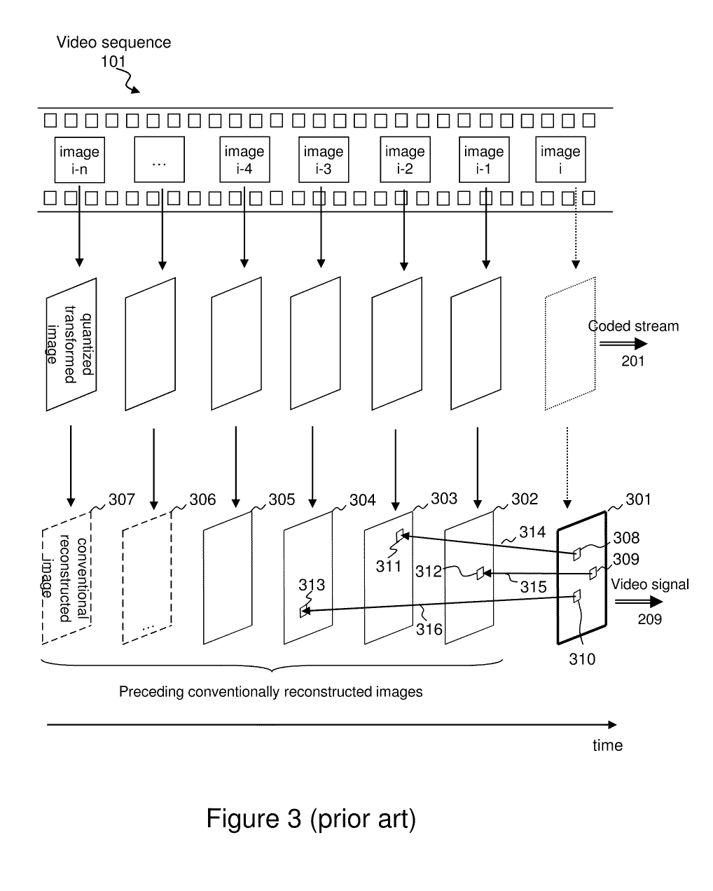

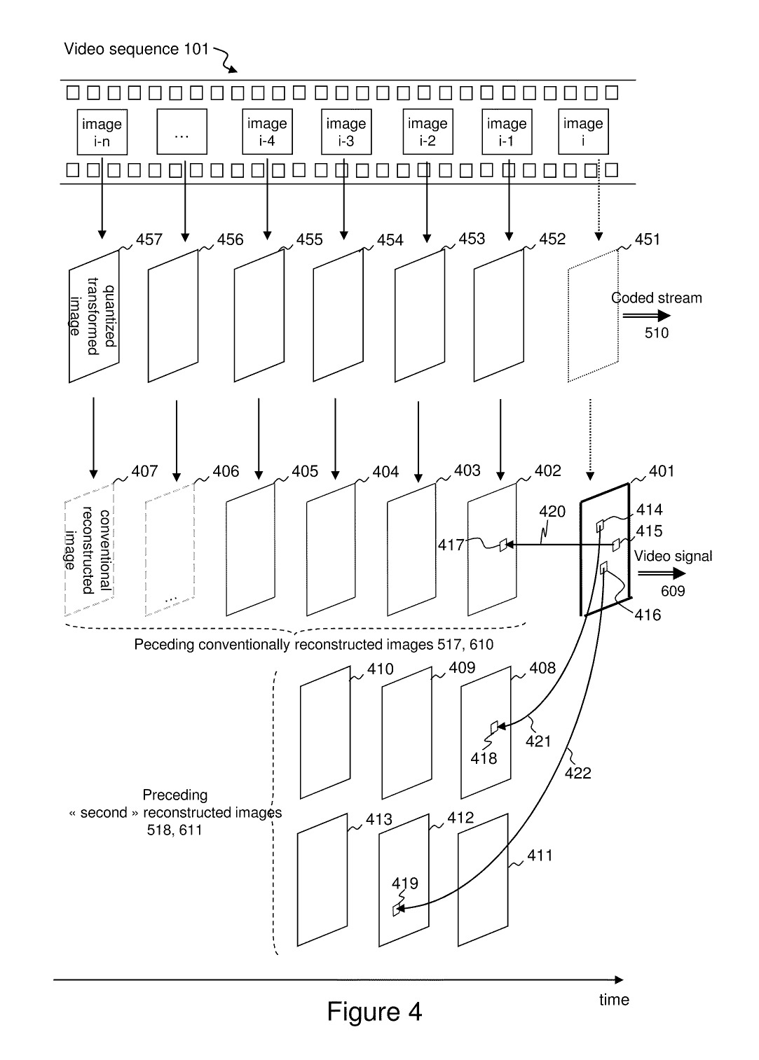

FIG. 4 illustrates a motion compensation implementing the invention, in a similar representation to that of FIG. 3.

The “conventional” reference images 402 to 405, that is to say obtained using the techniques of the prior art, and the new reference images 408 to 413 generated by the present invention are represented on an axis perpendicular to that of time (defining the video sequence 101) in order to show which images generated by the invention correspond to the same conventional reference image.

More particularly, the conventional reference images 402 to 405 are images of the video sequence which were previously encoded then decoded by the decoding loop: these images thus correspond to the video signal 209 of the decoder.

The images 408 and 411 result from other instances of decoding the image 452, also termed “second” reconstructions of the image 452. The “second” instances of decoding or reconstructions signify instances of decoding/reconstructions with different parameters to those used for the conventional decoding/reconstruction (in a standard coding format for example) provided to generate the decoded video signal 209.

As seen subsequently, these different parameters may comprise a DCT block coefficient and a quantization offset θᵢ applied at the time of reconstruction.

As is known per se, the blocks constituting an image comprise a plurality of coefficients each having a value. The manner in which the coefficients are scanned inside the blocks, for example a “zigzag scan” in anglo-saxon terminology, defines a coefficient number for each block coefficient. For the continuation of the description, we shall refer equally to “block coefficient”, “coefficient index” and “coefficient number” to indicate the position of a coefficient inside a block in respect to the selected scan path. Furthermore, we shall refer to “coefficient value” to indicate the value adopted by a given coefficient in a block.

Similarly, the images 409 and 412 are instances of second decoding of the image 403. Lastly, the images 410 and 413 are instances of second decoding of the image 404.

According to the invention as illustrated in this example, the current image blocks (i, 401) which must be processed (compressed) may each be predicted by a block of the previously decoded images 402 to 407 or by a block from a “second” reconstruction 408 to 413 of one of those images 452 to 454.

In this Figure, the block 414 of the current image 401 has, as Inter predictor block, the block 418 in the reference image 408 which is a “second” reconstruction of the image 452. The block 415 of the current image 401 has, as predictor block, the block 417 in the conventional reference image 402. Lastly, the block 416 has as predictor the block 419 in the reference image 413 which is a “second” reconstruction of the image 453.

In general terms, the “second” reconstructions 408 to 413 of a conventional reference image or of several conventional reference images 402 to 407 may be added to the list of the reference images 116, 208, or even replace one or more of those conventional reference images.

It will be noted that, generally, it is more efficient to replace the conventional reference images by “second” reconstructions, and to keep a limited number of new reference images (reconstructed multiples), rather than always to add these new images to the list. More particularly, a high number of reference images in the list increases the rate necessary for the coding of an index of those reference images (to indicate to the decoder which to use).

Similarly, it has been possible to observe that the use of multiple “second” reconstructions of the first reference image (that which is the closest temporally to the current image to process, generally the image preceding it) is more efficient than the use of multiple reconstructions of a temporally more remote reference image.

In order to identify the reference images used during the encoding, the coder transmits prediction information relating to the reference images used during the prediction of the different blocks of the image. As will be seen later, the invention proposes a compact signalling method of this information in the bit stream which results from coding the video sequence.

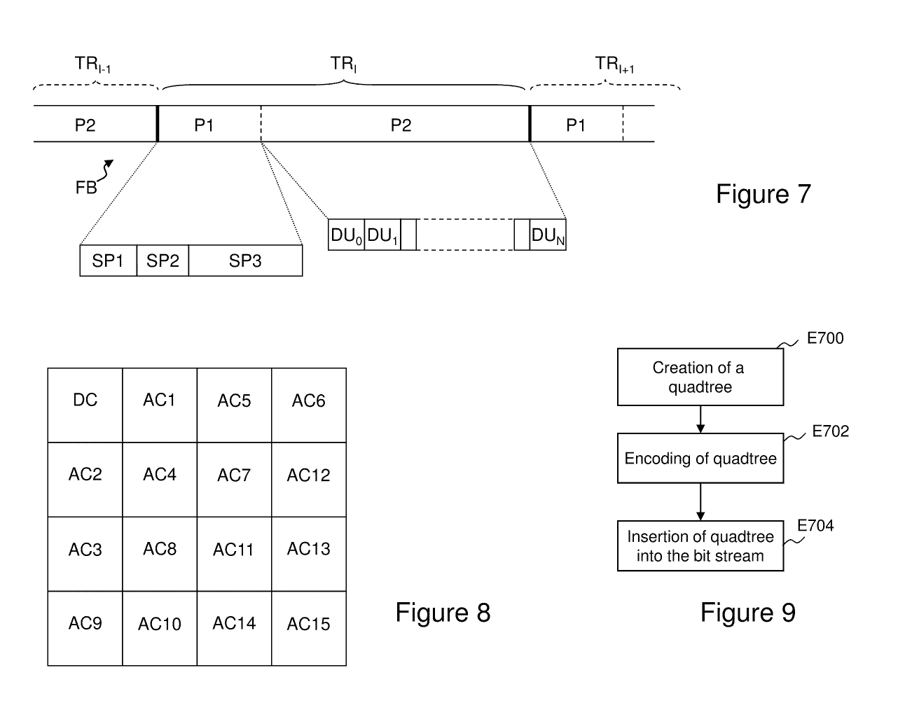

As illustrated in FIG. 7, the bit stream FB is composed of frames TR_{I} each corresponding to the coding information of an image ‘I’ in the sequence 101, frame TR_{I} corresponding to image ‘I’. In a simple example, the frames are in the same order as the images in the video sequence. However, they may differ from this order.

Each frame TR_{I} is composed of a first frame portion P1 (frame header) comprising in particular the prediction information relating to the whole of the reference images used during the coding of the corresponding image I, and of a second frame portion P2 which comprises the useful data approximately corresponding to the coded data for the block residues as calculated below.

It will be demonstrated below that implementing the invention avoids any reference to the reference images inside the useful data (second frame portion), contrary to standard H.264 which explicitly provides for indication of the reference image used in the useful data for each block.

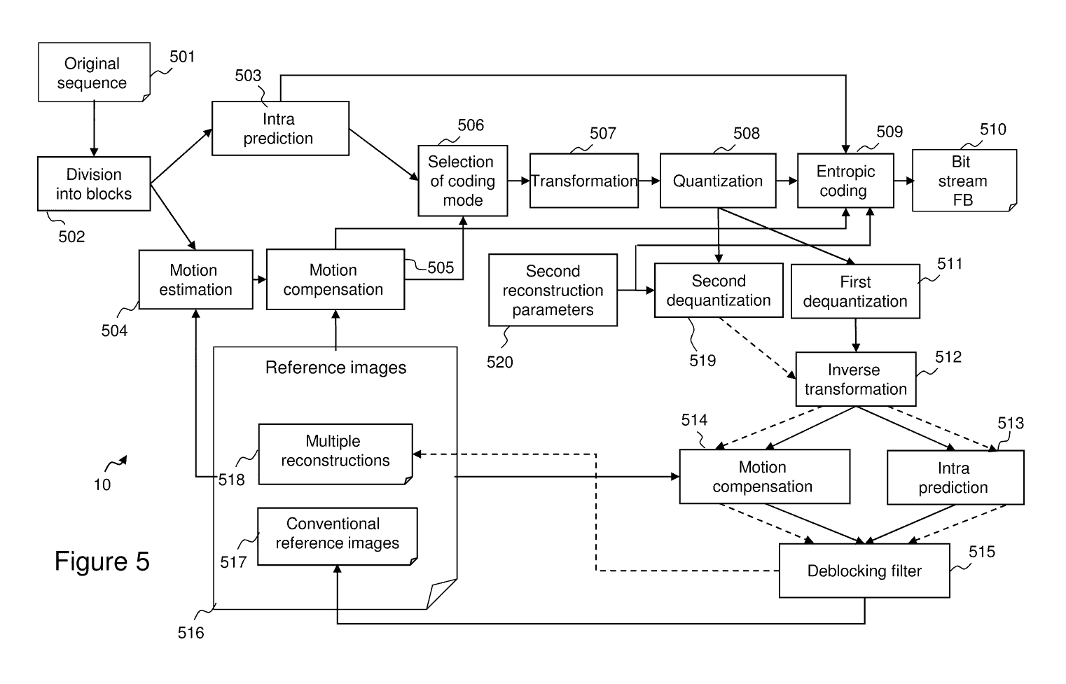

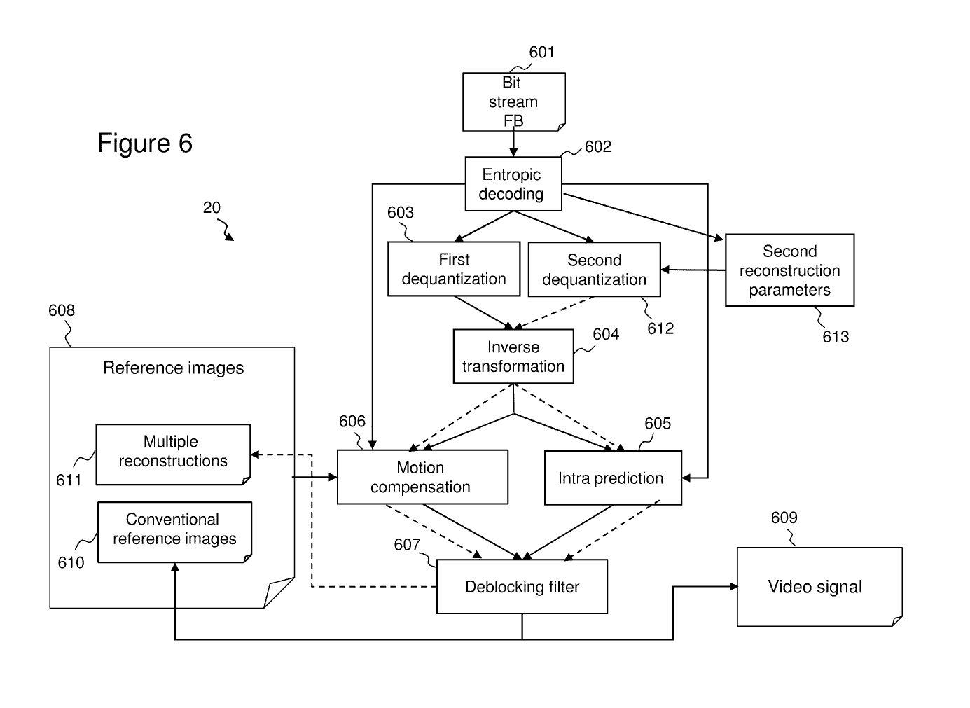

In reference to FIGS. 5 to 6, a main embodiment of the invention for generating multiple reconstructions of a conventional reference image, both during the encoding of a video sequence, and during the decoding of an encoded sequence, will now be described.

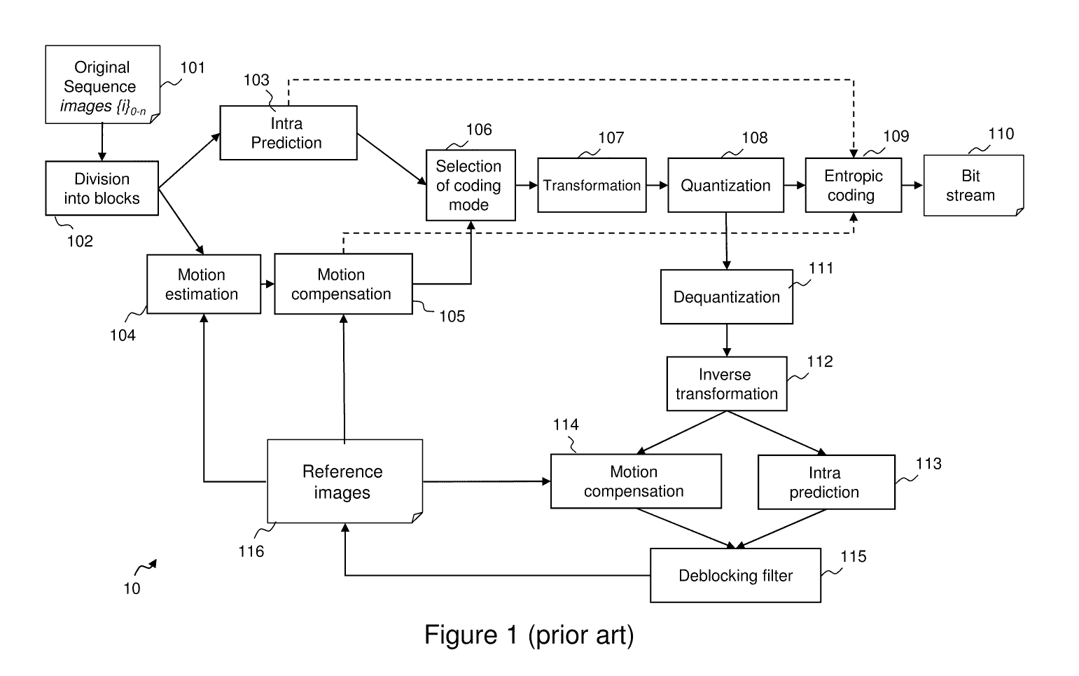

In reference to FIG. 5, a video encoder 10 according to the first embodiment of the invention comprises processing modules 501 to 515 of a video sequence with decoding loop, similar to modules 101 to 115 in FIG. 1. In particular, the “Inter” temporal prediction can be handled from conventional reference images 517 or from reconstructions 518 as presented later.

In particular, according to the H.264 standard, the quantization module 108/508 performs a quantization of the residue obtained after transformation 107/507, for example of DCT type, on the residue of the current block of pixels. The quantization is applied to each of the N coefficient values of that residual block (as many coefficients as there are in the initial block of pixels). The calculation of a matrix of DCT coefficients and the scan path of the coefficients within the matrix of DCT coefficients are concepts widely known to the person skilled in the art and will not be detailed further here. Such a scan path through the matrix of DCT coefficients makes it possible to obtain an order of the coefficients in the block, and therefore an index number for each of them.

By way of example, FIG. 8 shows a DCT 4×4 block in which the continuous DC coefficient and the different non zero frequency coefficients ACᵢ have been indicated according to a zigzag scan.

Thus, if the value of the i^{th} coefficient of the residue of the current block is called Wᵢ (with i from O to M−1 for a block containing M coefficients), for example W₀=DC and Wᵢ=ACᵢ), the quantized coefficient value Zᵢ is obtained by the following formula:

$${Z}_{i} = int ( \frac{\vert {W}_{i} \vert + {f}_{i}}{{q}_{i}} ) \cdot sgn ( {W}_{i} )$$

where qᵢ is the quantizer associated to the i^{th} coefficient whose value depends both on a quantization step size denoted QP and the position (that is to say the number or index) of the coefficient value Wᵢ in the transformed block.

To be precise, the quantizer qᵢ comes from a matrix referred to as a quantization matrix of which each element (the values qᵢ) is predetermined. The elements are generally set so as to quantize the high frequencies more strongly.

Furthermore, the function int(x) supplies the integer part of the value x and the function sgn(x) gives the sign of the value x

Lastly, fᵢ is the quantization offset which enables the quantization interval to be centered. If this offset is fixed, it is general equal to qᵢ/2.

At the end of this step, there are obtained for each image quantified residual blocks ready to be coded in the useful data portion P2, to generate the bit stream FB 510. In FIG. 4, these images have the references 451 to 457 and correspond to images i-n to i.

At will be seen next, prediction information (identification of reference image, reconstruction parameters, etc.) is also available relating to the images which have served as a basis for predictions of the image blocks undergoing coding. This prediction information itself is inserted into portion P1, as described later.

The inverse quantization (or dequantization) process, represented by the module 111/511 in the decoding loop of the encoder 10, provides for the dequantized value W′ᵢ of the i^{th} coefficient to be obtained by the following formula:

W′ᵢ=(qᵢ·|Zᵢ|−θᵢ)·sgn(Zᵢ)

In this formula, Z, is the quantized value of the i^{th} coefficient, calculated with the above quantization equation. θᵢ is the reconstruction offset that makes it possible to center the reconstruction interval. By nature, θᵢ must belong to the interval [−|fᵢ|; |fᵢ|]. To be precise, there is a value of θᵢ belonging to this interval such that W′ᵢ=Wᵢ. This offset is generally equal to zero.

It should be noted that this formula is also applied by the decoder 20, at the dequantization 203 (603 as described below with reference to FIG. 6).

Still with reference to FIG. 5, box 516 contains the reference images in the same way as box 116 of FIG. 1, that is to say that the images contained in this module are used for the motion estimation 504, the motion compensation 505 on coding a block of pixels of the video sequence, and the motion compensation 514 in the decoding loop for generating the reference images.

To illustrate the present invention, the reference images 517 referred to as “conventional” have been shown schematically, within box 516, separately from the reference images 518 obtained by “second” decoding/reconstruction according to the invention.

In this first embodiment of the invention, the “second” reconstructions of an image are constructed within the decoding loop, as represented by the modules 519 and 520, allowing at least one “second” decoding by dequantization (519) using “second” reconstruction parameters (520).

As a variant, however, the dequantized block coefficients could be recovered directly by the conventional means (output from module 511). In this case, at least one corrective residue is determined by applying an inverse quantization of a block of coefficients equal to zero, using the desired reconstruction parameters, then this corrective residue is added to the conventional reference image (either in its version before inverse transformation or after the filtration 515). Thus, the “second” reference image corresponding to the parameters used is obtained.

This variant offers lesser complexity while preserving identical performances in terms of rate-distortion of the encoded/decoded video sequence.

Returning to the embodiment first described, for each of the blocks of the current image, two dequantization processes (inverse quantization) 511 and 519 are used: the conventional inverse quantization 511 for generating a first reconstruction and the different inverse quantization 519 for generating a “second” reconstruction of the block (and thus of the current image).

It should be noted that, in order to obtain multiple “second” reconstructions of the current reference image, a larger number of modules 519 and 520 may be provided in the encoder 10, each generating a different reconstruction with different parameters as explained below In particular, all the multiple reconstructions can be executed in parallel with the conventional reconstruction by the module 511.

Prediction information including the parameters associated with these multiple reconstructions are inserted into the P1 portions of the coded stream FB 510 (in particular in the TR frames using predictions based on these reconstructions) so as to inform the decoder 20 of the values to be used. The step of forming this P1 portion will be detailed below.

The module 519 receives the parameters of a second reconstruction 520 different from the conventional reconstruction. The operation of this module 520 will be described below. The parameters received are for example a coefficient number i of the transformed residue which will be reconstructed differently and the corresponding reconstruction offset θᵢ, as described elsewhere The number of a coefficient is typically its number in a convention order such as a zig-zag scan.

These parameters can in particular be determined in advance and be the same for all the reconstruction (that is, all the sets of pixels) of the corresponding reference image. Alternatively, they may vary from one image block to the other.

However, the invention allows efficient signalling of this information in portion P1 of a frame TR corresponding to an image to be coded, when it is used in the prediction process of at least one block of this image to be coded.

When these two parameters (coefficient number and offset θᵢ) generated by the module 520 are used to predict one or several blocks of the image to be coded, they are coded by entropic coding at module 509 then inserted into portion P1 of the frame TR corresponding to this image.

In an example for module 519, the inverse quantization to calculate W′ᵢ is applied for the coefficient i and the reconstruction offset θᵢ defined in the parameters 520. In an embodiment, for the other block coefficients the inverse quantization is applied with the conventional reconstruction offset (used in module 511). Thus, in this example, the “second” reconstructions may differ from the conventional reconstruction through the use of only one different pair (coefficient, offset).

As will be seen below, several reconstruction offsets θᵢ may be applied to several coefficients within the same block, or indeed different pairs {offset; coefficient} from one block to the other.

Thus, henceforth the conventional reconstruction may be identified by the image (“i-1” for example) to which it corresponds (the offsets are for example zero for all the coefficients of all the blocks) and each “second” reconstruction identified by this same image (“i-1”) and the pairs {offset; coefficient} used with possibly the blocks to which these couples are applied.

At the end of the second inverse quantization 519, the same processing operations as those applied to the “conventional” signal are performed. In detail, an inverse transformation 512 is applied to that new residue (which has thus been transformed 507, quantized 508, then dequantized 519). Next, depending on the coding of the current block (Intra or Inter), a motion compensation 514 or an Intra prediction 513 is performed.

Lastly, when all the blocks (414, 415, 416) of the current image have been decoded. This new reconstruction of the current image is filtered by the deblocking filter 515 before being inserted among the multiple “second” reconstructions 518.

Thus, in parallel, there are obtained the image decoded via the module 511 constituting the conventional reference image, and one or more “second” reconstructions of the image (via the module 519 and other similar modules the case arising) constituting other reference images corresponding to the same image of the video sequence.

In FIG. 5, the processing according to the invention of the residues transformed, quantized and dequantized by the second inverse quantization 519 is represented by the arrows in dashed lines between the modules 519, 512, 513, 514 and 515.

It will therefore be understood here that, like the illustration in FIG. 4, the coding of the following image may be carried out by block of pixels, with motion compensation with reference to any block from one of the reference images thus reconstructed.

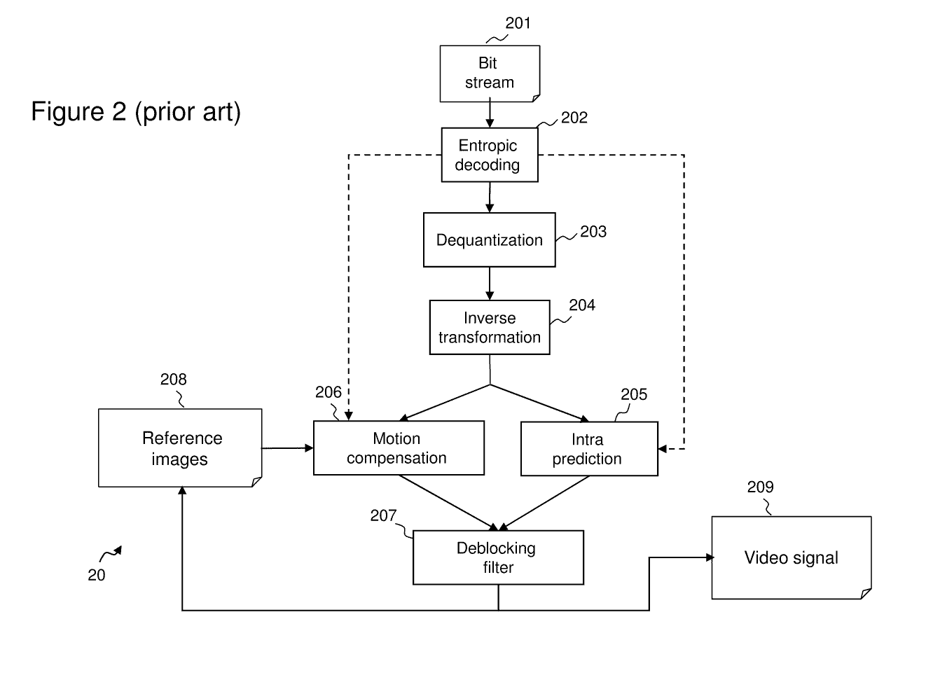

With reference now to FIG. 6, a decoder 20 according to the first embodiment comprises decoding processing modules 601 to 609 equivalent to the modules 201 to 209 described above in relation to FIG. 2, for producing a video signal 609 for the purpose of a reproduction of the video sequence by display. In particular, the dequantization module 603 implements for example the formula W′ᵢ=(qᵢ·|Zᵢ|−θᵢ)·sgn(Zᵢ) disclosed previously.

By way of illustration and for reasons of simplification of representation, the images 451 to 457 (FIG. 4) may be considered as the coded images constituting the bitstream 510 (the entropy coding/decoding not modifying the information of the image). The decoding of these images generates in particular the conventional reconstructed images making up the output video signal 609.

The reference image module 608 is similar to the module 208 of FIG. 2 and, by analogy with FIG. 5, it is composed of a module for the multiple “second” reconstructions 611 and a module containing the conventional reference images 610.

At the start of decoding of the current image, portion P1 is extracted from the bit stream 601 and decoded entropically to obtain the prediction information, that is, for example, the pairs of parameters (coefficient number and corresponding offset) of the “second” reconstructions and possibly the images “i-n” to “i-1” to which they refer. This information is then transmitted to the second reconstruction parameters module or modules 613.

In this example, the process of a single second construction is described, although in the same manner as for the coder 10, other reconstructions may be performed, possibly in parallel, with suitable modules.

Thus a second dequantization module 612 calculates, for each data block, an inverse quantization different from the “conventional” module 603.

In this new inverse quantization, for the coefficient number or numbers given in parameter 613, the dequantization equation is applied with the reconstruction offset or offsets θᵢ likewise supplied by the second reconstruction parameters module 613.

The values of the other coefficients of each residue are, in this embodiment, dequantized with a reconstruction offset similar to the module 603, generally equal to zero.

As for the encoder, the residue (transformed, quantized, dequantized) output from the module 612 is detransformed (604) by application of the transform that is inverse to the one 507 used on coding.

Next, depending on the coding of the current block (Intra or Inter), a motion compensation 606 or a Intra prediction 605 is performed.

Lastly, when all the blocks of the current image have been decoded, the new reconstruction of the current image is filtered by the deblocking filter 607 before being inserted among the multiple “second” reconstructions 611.

This path for the residues transformed, quantized and dequantized by the second inverse quantization 612 is symbolized by the arrows in dashed lines. It should be noted that these “second” reconstructions of the current image are not used as video signal output 609. To be precise, these other reconstructions are only used as supplementary reference images for later predictions, whereas only the image reconstructed conventionally constitutes the video output signal 609.

Because of this non-use of the “second” reconstruction as an output signal, in a variant embodiment aimed at reducing the calculations and the processing time, it is provided to reconstruct, as a “second” reconstruction, only the blocks of the “second” reconstruction that are actually used for the motion compensation “Actually used” means a block of the “second” reconstruction that constitutes a reference (that is to say a block predictor) for the motion compensation for a block of a subsequently encoded image in the video sequence.

As will be demonstrated later, the signalling of the prediction information in portion P1 allows a simple implementation of this “partial” reconstruction limited to certain image zones and not to the entirety of each image.

The functioning of module 520 will now be described for the selection of associated optimum reconstruction coefficients and shifts. It will be noted, however, that these selection mechanisms are not the core of the present invention and are described here only by way of examples.

The algorithms described below may in particular be implemented for selections of parameters of other types of decodings/reconstructions of a current image in several “second” reconstructions: for example reconstructions applying a contrast filter and/or a blur filter to the conventional reference image.

In this case, the selection may consist of choosing a value for a particular coefficient of a convolutional filter used in these filters, or selecting the size of this filter.

It will be noted that module 613 provided in the decoding only generally recovers information from the bit stream FB.

As introduced above, in the embodiment described here, two parameters are used to achieve a “second” reconstruction of an image that is referenced “I”: the number i of the coefficient to dequantize differently and the reconstruction offset θᵢ which is selected to achieve this different inverse quantization.

Module 520 performs an automatic selection of these parameters for a second reconstruction.

In detail, in regards to the quantization offset (shift), to simplify the explanations it is immediately considered that the quantization offset fᵢ of equation

$${Z}_{i} = int ( \frac{\vert {W}_{i} \vert + {f}_{i}}{{q}_{i}} ) \cdot sgn ( {W}_{i} )$$

above is systematically equal to qᵢ/2. By virtue of the quantization and inverse quantization processes, the optimum reconstruction offset θᵢ pertains to interval [−qᵢ/2; qᵢ/2].

As stated above, the “conventional” reconstruction to generate the signal 609 generally uses a zero offset (θᵢ=0)

Several approaches to fix the offset associated with a given coefficient (the coefficient selection is described below), for a “second” reconstruction may thus be envisaged. Even if an optimum offset can be calculated for each of the (sixteen) block coefficients, the reduction to a sub-set of all of the block coefficients to be taken into account can advantageously be envisaged. In particular, this reduction may consist of selecting the coefficients whose DCT are on average highest in the different DCT image blocks.

Thus, generally the continous DC coefficient and the first ACⱼ coefficients will be preserved.

Once the sub-set has been established, the offset associated with each of the coefficients i in this sub-set or in the sixteen DCT coefficients if the sub-set reconstruction is not implemented, is established according to one of the following approaches:
according to a first approach: the choice of θᵢ is fixed according to the number of multiple “second” reconstructions of the current image already inserted in the list 518/718 of the reference images. This configuration provides reduced complexity for this selection process. This is because it has been possible to observe that, for a given coefficient, the most effective reconstruction offset θᵢ is equal to qᵢ/4 or −qᵢ/4 when a single reconstruction of the first image belongs to all the reference images used. When two “second” reconstructions are already available (using qᵢ/4 and −qᵢ/4), an offset equal to qᵢ/8 or qᵢ/8 gives the best mean results in terms of rate/distortion of the signal for the following two “second” reconstructions, etc;
according to a second approach: the offset θᵢ may be selected according to a rate/distortion criterion. If it is wished to add a new “second” reconstruction of the first reference image to all the reference images, then all the values (for example integers) of θᵢ belonging to the interval [−qᵢ/2; qᵢ/2] are tested; that is to say each reconstruction (with θᵢ different for the given coefficient i) is tested within the coding loop. The quantization offset that is selected for the coding is the one that minimizes the rate/distortion criterion;
according to a third approach: the offset θᵢ that supplies the reconstruction that is most “complementary” to the “conventional” reconstruction (or to all the reconstructions already selected) is selected. For this purpose, the number of times where a block of the evaluated reconstruction (associated with an offset θᵢ, which varies over the range of possible values because of the quantization step size QP) supplies a quality greater than the “conventional” reconstruction block (or than all the reconstructions already selected) is counted, the quality being able to be assessed with a distortion measurement such as an SAD (absolute error—“Sum of Absolute Differences”), SSD (quadratic error—“Sum of Squared Differences”) or PSNR (“Peak Signal to Noise Ratio”). The offset θᵢ that maximizes this number is selected. According to the same approach, it is possible to construct the image each block of which is equal to the block that maximizes the quality among the block with the same position in the reconstruction to be evaluated, that of the “conventional” reconstruction and the other second reconstructions already selected. Each complementary image, corresponding to each offset θᵢ (for the given coefficient), is evaluated with respect to the original image according to a quality criterion similar to those above. The offset θᵢ the image of which constructed in this way maximizes the quality, is then selected.

Now is described the selection of the coefficient to be modified. This choice consists of selecting the optimum coefficient from among the sub-set coefficients when the latter is constructed, or from among the sixteen block coefficients.

Several approaches are then envisaged, the best offset θᵢ being already known for each of the coefficients as determined above:
first of all, the coefficient used for the second reconstruction is predetermined. This manner of proceeding gives low complexity. In particular, the first coefficient (coefficient denoted “DC” in the state of the art) is chosen. To be precise, it has been possible to note that the choice of this DC coefficient enables “second” reconstructions to be obtained having the best mean results (in terms of rate-distortion).
in a variant, the reconstruction offset θᵢ being set, determining θᵢ is carried out in similar manner to the second approach above: the best offset for each of the coefficients of the block or of the subset I′ is applied and the coefficient which minimizes the rate-distortion criterion is selected.
in another variant, the coefficient number may be selected in similar manner to the third approach above to determine θᵢ: the best offset is applied for each of the coefficients of the subset I′ or of the block and selection is made the coefficient which maximizes the quality (greatest number of blocks evaluated having a quality better than the “conventional” block).
in still another variant, it is possible to construct the image each block of which is equal to the block that maximizes the quality, among the block with the same position in the reconstruction to be evaluated, those of the “conventional” reconstruction and the other second reconstructions already selected. The coefficient from the block or the subset I′ which maximizes the quality is then selected.

These several examples of approaches provide the module 520 with pairs (coefficient number; reconstruction offset) to pilot module 519 and achieve as many “second” reconstructions.

Although the selection is mentioned here of a coefficient i and its corresponding offset for a “second” reconstruction, it will be recalled that mechanisms providing several pairs of parameters which may vary from block to block may be envisaged, and in particular an arbitrary selection by a user.

The step of forming the bit stream BF at the encoder 10 to achieve efficient signalling of the prediction information used during coding of the images (resulting in portion P2 of useful data) will now be described in reference to FIGS. 7, 9 to 12. The use of this information at decoder 20 will also be described.

As explained above, module 509 recovers progressively as the coding of each block, noted Bₖ, of the current image I goes, this prediction information, noted IPₖ, used during this coding, along with the useful data, noted DUₖ, resulting from the entropic coding of the block residue.

As shown in FIG. 7, the useful data DUₖ of each block Bₖ of the current image I is subsequently inserted into portion P2 of frame TR_{I} corresponding to this image I. Similarly to H.264, the motion vector used in the prediction of each block is coded at the useful data DUₖ.

In one embodiment, the prediction information IPₖ relating to a coded block Bₖ comprises:
the index of the reference image used: I-n to I-1. Generally, the image I-1 serves as reference;
the number NCₖ of modified coefficients in the predictor block in relation to the same block of the “conventional” reference image. In particular, as the “conventional” reference image generally uses zero offsets for all the coefficients, this number indicates the number of non-zero offsets in the reconstruction of this predictor block;
the index i of each of the modified coefficients;
and for each of these coefficients, the corresponding offset θᵢ.

FIG. 9 shows the steps performed by the coder to generate the portion P1 signalling the set of prediction information in the bit stream FB.

These comprise a first construction step E700 of a tree structure, for example, a quadtree or any other suitable structure (octree, etc.), for memorizing the prediction information IPₖ for the set of blocks of the current image.

This step is followed by a coding step E702 of this structure in portion P1, then the insertion E704 of this portion into the bit stream FB 510 at the start of frameTR_{I}.

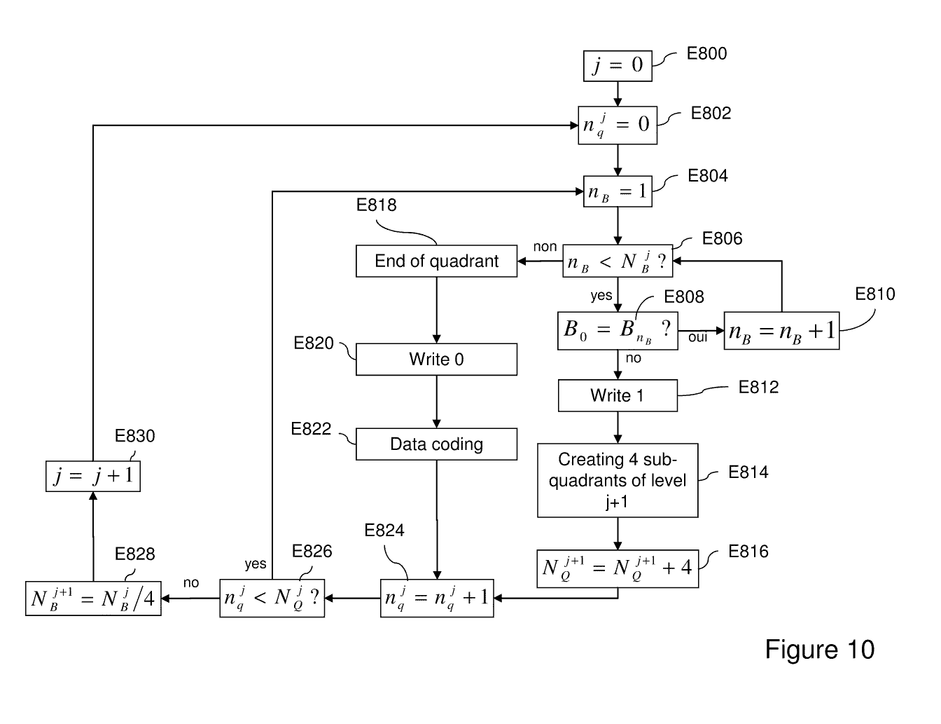

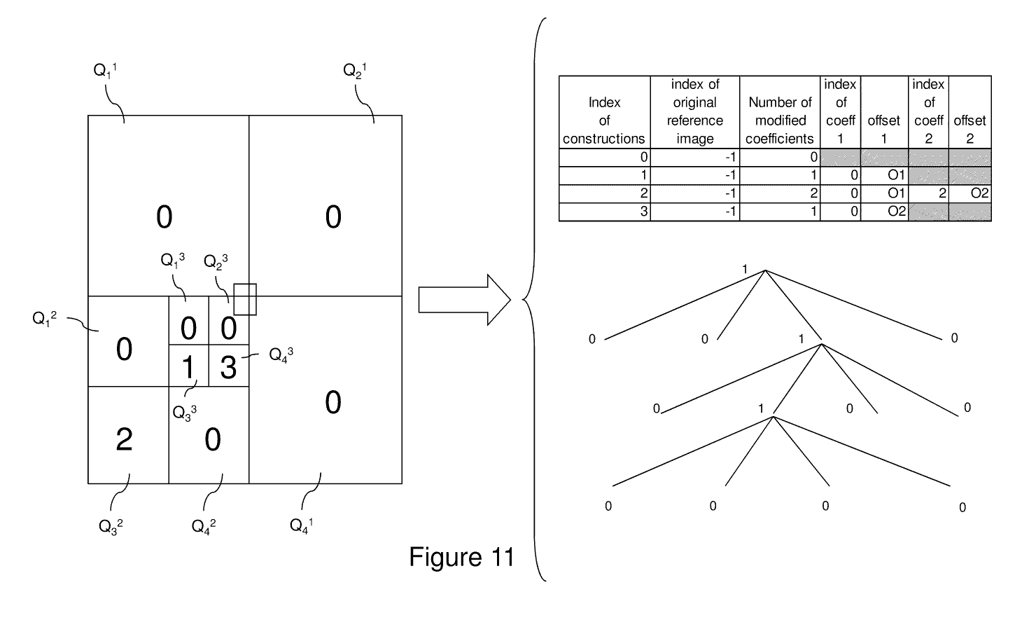

FIG. 10 illustrates the formulation and construction of a quadtree an example of which is provided in FIG. 11.

As is shown in the left-hand presentation in FIG. 11, spatial zones of image I are determined whose constituent blocks use the same prediction information (same image acting as reference, same pairs of parameters) so as to jointly process (code or decode) this prediction information for several spatially close blocks. In effect, due to the strong spatial correlation between close blocks, a large number of close blocks will frequently use the same reconstruction or the same reconstruction parameters to define the predictor block. The most simple case is that of adjacent blocks.

These spatial zones may in particular be obtained by a subdivision of the current image into a quadtree, that is into recursive quadrants and sub-quadrants, which is the case in FIG. 11.

Returning to FIG. 10, the processing starts with the initialization to 0 (E800) of a variable ‘j’ representing a subdivision level (j=0 for the entire image, j=1 for the four quadrants Q₁¹-Q₄¹, etc. for the sub-quadrants Q_{α}^{j}), the initialization to 0 (E802) of a second variable n_{q}^{j} representing the number of a (sub)-quadrant Qₙ_{_{q}}_{^{j}}^{j} to be processed at subdivision level j, then initialization to 1 (E804) of a variable n_{B} representing the number of a current block Bₙ_{_{B}} being studied in the current (sub)-quadrant.

It will be noted that henceforth the quadrants and sub-quadrants are scanned from left to right then from top to bottom. The same applies for the blocks B composing a quadrant or sub-quadrant.

Furthermore, it can be noted that at a given subdivision level j, the number N_{B}^{j} of blocks comprising a (sub)-quadrant Qₙ_{_{q}}_{^{j}}^{j} is known or easily determinable: N_{B}⁰=the number of blocks in the image; N_{B}^{j}=N_{B}⁰/2^{2j}. Similarly, the maximum number N_{MAX-Q}^{j} of (sub)-quadrants in a hierarchical level is likewise known: N_{MAX-Q}^{j}=2^{2j}. Thus N_{B}^{j}=N_{B}⁰/N_{MAX-Q}^{j}.

The use of these three variables (j, n_{q}^{j}, n_{B}) allows the current image to be subdivided recursively into (sub)-quadrants by analyzing blocks B of which the latter are composed.

To this end, at step E806, a test is made as to whether the number n_{B} of the current block is strictly less than the number N_{B}^{j}.

If this is the case, an analysis is pursued of the current (sub)-quadrant Qₙ_{_{q}}_{^{j}}^{j} by comparing (E808) the current block Bₙ_{_{B}} with the first block B₀ of the current (sub)-quadrant. The initialization E804 permits the useless comparison of B₀ with itself to be dispensed with.

At this step E808, a check is made as to whether the reference image and the reconstruction parameters used to predict the block B₀ are the same as those used for the prediction of block Bₙ_{_{B}}. If this is the case, the two blocks are considered as similar for the purposes of the present invention. If this is not the case, they are different.

It will be noted that certain blocks are not temporally predicted (“infra” prediction or absence of prediction). In this case, by default, they are considered to be similar to block B₀ at this step E808 in order to benefit the groupings.

It is to be noted that when the block B₀ is not temporally predicted, the first block predicted temporally in the current (sub)-quadrant is taken as reference block (by replacement of B₀ for test E808).

Should the two blocks be similar (YES output from test E808), n_{B} is increased (E810) to compare the following block after test E806. Thus, the set of blocks in the current (sub)-quadrant is run through until one block is different from block B₀ according to the invention.

If a block proves different from block B₀ (NO output from test E808), the analysis of the current (sub)-quadrant is halted and the current (sub)-quadrant must be divided. To this end, a bit equal to ‘1’ is inserted (E812) into a first sub-portion SP1 of header P1 (see FIG. 7) to indicate this division in the stream FB. This sub-portion SP1 corresponds to the quadtree in which a ‘1’ indicates that a (sub)-quadrant is divided into four sub-quadrants in the following subdivision level. Correlatively, a ‘0’ will indicate that a (sub)-quadrant is not divided into a following subdivision level.

Following step E812, the current (sub)-quadrant Qₙ_{_{q}}_{^{j}}^{j} is divided (E814) into four sub-quadrants Qₙ_{_{q}}_{^{j+1}}^{j+1}, then the number of (sub)-quadrants of the following subdivision level ‘j+1’ is increased by 4: N_{Q}^{j+1}=N_{Q}^{j+1}+4 (E816). Naturally, at the start of processing, the N_{Q}^{j} numbers are all zero with the exception of N_{Q}⁰ which equals 1 (the entire image).

Correlatively, if all the blocks in the current (sub)-quadrant Qₙ_{_{q}}_{^{j}}^{j} (E818) (NO output from test E806) have been processed, this means that all the blocks of this (sub)-quadrant are similar in the meaning of the invention. In this case, a bit equalling ‘0’ is then inserted (E820) into the first sub-portion SP1 of header P1 to indicate that there is no need to divide this (sub)-quadrant.

The prediction information common to the set of blocks comprising this current (sub)-quadrant is then encoded: index I-n to I-1 of the reference image used; the number NCₖ of modified coefficients; the index i of each of the modified coefficients; and the corresponding offset θᵢ.

This encoding consists of:

(1) determining if this x-uplet is already present in the third sub-portion SP3 of the frame header P1. In effect, as will be seen below, sub-portion SP3 memorizes the x-uplets used for the coding of image I;

(2) if this is not the case (SP3 being empty for example), the x-uplet is subsequently encoded in binary manner in sub-portion SP3 and an index indicating the position of the thus coded x-uplet in sub-portion SP3 is then added in the second sub-portion SP2 of the header P1;

(3) if this is the case (x-uplet already present in SP3), the index indicating the position of the x-uplet in SP3 is subsequently inserted directly into the second sub-portion SP2.

It can therefore be seen here that the structure SP1-SP2-SP3 constitutes a quadtree type tree structure representing a subdivision of the image into spatial zones indicating for each of them the parameters (x-uplet) used for the temporal prediction of the blocks in this zone. Each so constructed spatial zone (quadrant and sub-quadrant) groups blocks which are similar in the meaning of the invention, these blocks being spatially close and, for example, adjacent.

The above case (3) in particular allows a reduction in the amount of data used as, in addition to factoring the prediction information resulting from the grouping in spatial zones, the same x-uplet is re-used for different distinct spatial zones.

Further to steps E816 and E822, the following (sub)-quadrant is selected by incrementing the number n_{q}^{j} of the current (sub)-quadrant: n_{q}^{j}=n_{q}^{j}+1 (E824).

It is then tested whether the set of (sub)-quadrants corresponding to the current subdivision level j has been processed. This test E826 consists of comparing n_{q}^{j} with the number N_{Q}^{j} of (sub)-quadrants in level j.

If n_{q}^{j}<N_{Q}^{j}, the (sub)-quadrant number n_{q}^{j} has not been processed and step E804 is returned to analyze each of the blocks in this (sub)-quadrant.

If n_{q}^{j}≧N_{Q}^{j} (all the sub-quadrants have been analyzed), a calculation is performed (E828) of the number N_{B}^{j+1} of blocks to be analyzed in each of the sub-quadrants in the subdivision level following j+1: N_{B}^{j+1}=N_{B}^{j}/4. In effect, at each following subdivision level, a quadrant is divided into four equal sub-quadrants.

Naturally, the person skilled in the art would be able to adapt these steps if another subdivision was used, for example a division into nine sub-quadrants.

The following subdivision level is then selected (E830), then step E802 is returned to successively process each of the N_{Q}^{j+1} sub-quadrants in subdivision level j+1.

The processing halts when no further following subdivision level exists, that is, once N_{Q}^{j}=0. It will be noted that the number J of subdivision levels evolves according to the implementation or not of step E814. Thus, during the division of step E814, the number J of subdivision levels is updated to allow for this new division.

Furthermore, the division into sub-quadrants E814 is not performed since this would create sub-quadrants smaller in size than an elementary block (here Bₖ). In this case, the current subdivision level j is the last level processed.

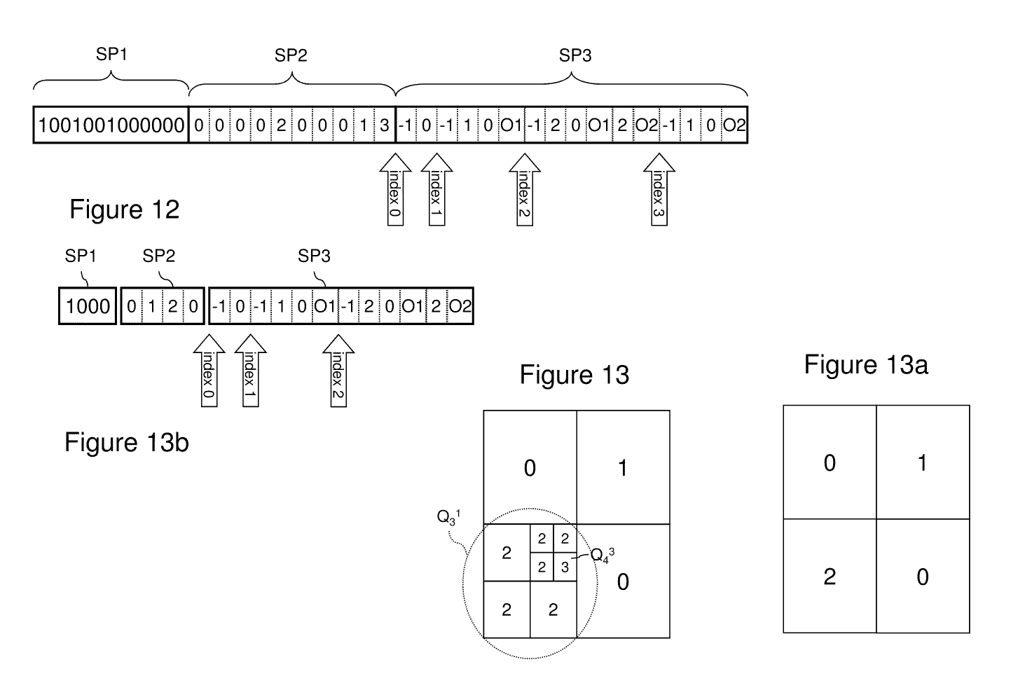

The example in FIGS. 11 and 12 results from the processing thus described. The image is subdivided into level 1 quadrants: Q₃¹, the third quadrant is subdivided into sub-quadrants Qᵢ², and the second sub-quadrant Q₂² is itself subdivided into level 3 sub-quadrants: Qᵢ³.

Each (sub)-quadrant resulting from the final subdivision is therefore a set of blocks Bₖ of the image which are similar to one another in the meaning of the invention.

The number indicated in each of the (sub)-quadrants notifies an internal identifier corresponding to a reconstruction memorized by the coder and thus to the reconstruction information associated with it. These reconstructions are listed in the table in the right-hand part of FIG. 11: the reconstruction ‘0’ (column one) corresponds to the “conventional” reconstruction of the image I-1 (column two—as a reminder, the current image to be coded is image ‘1’) no coefficient of which (column three) is modified.

The second line corresponds to the reconstruction ‘1’ of image I-1 one coefficient of which is modified in relation to the “conventional” reconstruction of the first line. In particular, the coefficient ‘0’ (continuous coefficient DC—column four) is modified using a quantization offset equal to O1 (column five).

The same is true for the reconstructions 2 and 3 which are reconstructions of image I-1 whose reconstruction parameters are respectively: {coefficient DC; offset O1+coefficient AC2; offset O2} and {coefficient DC; offset O2}.

The tree shown to the right corresponds to the subdivision of the image into (sub)-quadrants whose ‘0’ and ‘1’ correspond to the values entered in sub-portion SP1 during steps E812 and E820.

FIG. 12 shows the contents of header P1 before binary coding corresponding to this example and thus generated by the processing of FIG. 10.

Sub-portion SP1 comprises the thirteen bits describing the tree in FIG. 11; sub-portion SP2 comprises the indices corresponding to the x-uplets stored in SP3 for each of the ten (sub)-quadrants finally constituting the image (in sub-portion SP3 the different indices are shown by arrows); and sub-portion SP3 successively comprises the prediction information IPₖ (the x-uplets) corresponding to each of the reconstructions used for coding the current image I.

The header P1 thus shows the table and tree in FIG. 11. Hence, as an initial alternative, the coder may consequently compile the table and quadtree shown here, before proceeding to their encoding in the form of the stream shown in FIG. 12: the tree is encoded in SP1, each of the lines of the table (without column one) in SP3, and the link is made between each (sub)-quadrant indicated in SP1 and the x-uplets in SP3, by notifying, in SP2, the position of these x-uplets for each (sub)-quadrant.

In one embodiment of the invention intending to improve the video sequence compression by reducing the length of the header P1, it is envisaged, once the subdivision in FIG. 11 has been obtained, to identify any sub-quadrant associated with a particular reconstruction which is located in the center or among a large number of sub-quadrants all associated with the same other reconstruction.

This embodiment is illustrated using FIG. 13 in which the image is subdivided into ten (sub)-quadrants, of which one of the level 3 (Q₄³) sub-quadrants is associated with the reconstruction identified ‘3’ whereas the set of its adjacent sub-quadrants in quadrant Q₃¹ is associated with reconstruction ‘2’.

In this case, it is envisaged to force the association of this sub-quadrant Q₄³ with reconstruction ‘2’ in order to obtain a simpler subdivision composed only of four quadrants (see FIG. 13a). In this case, the coder then proceeds to a new prediction of the blocks concerned (those of Q₄³) using the reconstruction ‘2’ and consequently modifies the useful data associated with these blocks. The quadtree is likewise modified and the table is possibly simplified by eliminating the reconstructions which are henceforth no longer used. FIG. 13b illustrates portion P1 then obtained with the same reconstruction parameters as for FIG. 12.

Thus it can be seen that the number of data to be inserted into header P1 decreases without, however, introducing too great a distortion because Q₄³ is relatively small in relation to the grouping obtained.

Criteria may be implemented to force such an association, for example to authorize a grouping solely by (sub)-quadrant and if at least ¾ of the resulting (sub)-quadrant is associated with the same reconstruction.

The zone grouping may thus be forced, even if several sub-quadrants are associated with reconstructions different from the majority reconstruction inside the resulting spatial zone.

In another embodiment, a single image may be used as image from which the reconstructions of reference images are performed (this is the case in FIG. 11 with image I-1). In this case, transmission in SP3 of the identifier of this image may be avoided as it is the same for all the reconstructions.

A convention may permit the decoder to know this information: for example still use image I-1.

Thus, the video sequence compression is further improved.

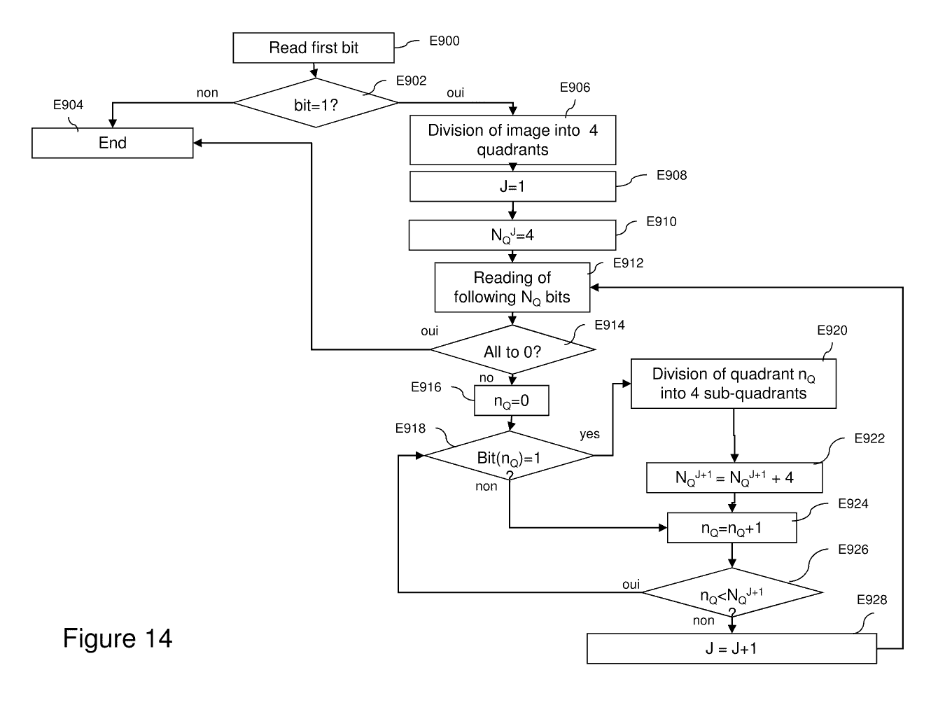

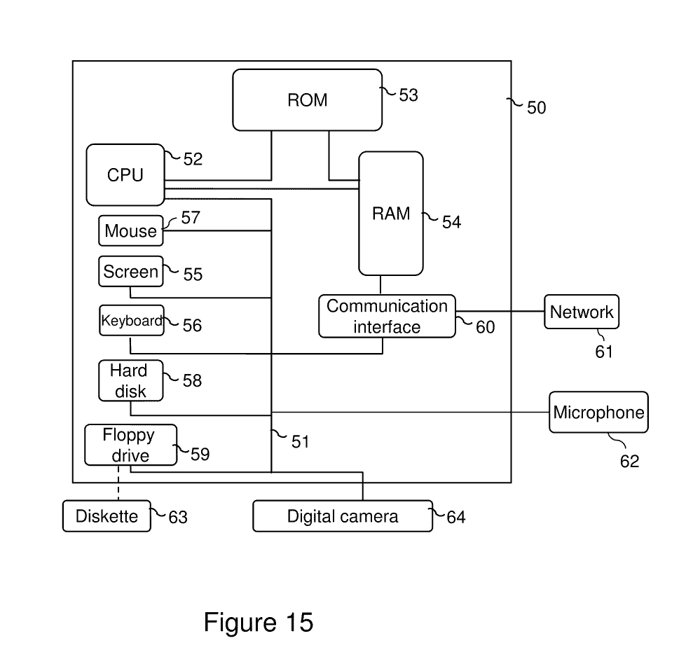

FIG. 14 shows the decoding, in particular of sub-portion SP1 of a frame TR to reconstitute the quadtree in FIG. 11.

In step E900, the first bit in frame TR is read to test if it equals 0 or 1 (E902). If it equals ‘0’, this means that the image is not subdivided (thus the same reference image is used for all the image blocks) and the decoding of SP1 is terminated (E904).

If the bit read equals 1, the current image I is divided into quadrants (E906), the subdivision level J is set to 1 (E908) and the number N_{Q}^{J} of quadrants for level 1 is set to 4 (E910).

The following N_{Q}^{J} bits in the bit stream FB are then read (E912). If all the bits are at 0, this means that the quadrants in the current level are not sub-divided (test E914), in which case the processing terminates in E904.

If a non-zero bit (NO output from test E914) exists, the (sub)-quadrant number variable n_{Q} is initialized to 0 (E916).

The first bit of the N_{Q}^{J} bits read is then considered (this concerns bit number n_{Q}) and a test is made as to whether this equals 1 (E918).

If this is so, (sub)-quadrant n_{Q} is itself divided into four sub-quadrants (E920), then the number of lower level sub-quadrants is increased by 4: N_{Q}^{j+1}=N_{Q}^{J+1}+4 (E922).

Following step E922 or if the n_{Q}th bit read is zero (sub-quadrant n_{Q} is not sub-divided), step E924 is moved to where n_{Q} is increased to pass to the following bit.

A check is then made as to whether all the bits (E926) have been processed. If this is not so, step E918 is returned to, otherwise step E928 is passed to where the number J of subdivision levels is increased. Finally, after step E928, step E912 is returned to process the bits corresponding to the following subdivision level.

At the end of this processing, the quadtree in FIG. 11 has been reconstructed, and the image I has been divided into a number of (sub)-quadrants corresponding to the number of ‘0’ in the sub-portion SP1 of the bit stream FB.

The continuation of the decoding of the current binary frame TR consists of running through the quadtree and, for each quadrant defined by the latter, of reading information from the second sub-portion SP2 to identify the location of the corresponding prediction information in sub-portion SP3.

The useful data P2 is then decoded block par block.

Thus, the data DUᵢ corresponding to a block is decoded by first determining if this block has been temporally predicted. If this is so, the prediction information (in SP3) corresponding to the quadrant to which the block belongs is recovered via the indication in SP2.

This prediction information enables reconstruction of the reference image used for this prediction. The continuation of the decoding of this block is conventional using this reference image.

With reference now to FIG. 15, a description is given by way of example of a particular hardware configuration of a video sequence processing device adapted for an implementation of the method according to the invention.

An information processing device implementing the present invention is for example a micro-computer 50, a workstation, a personal assistant, or a mobile telephone connected to different peripherals. According to still another embodiment of the invention, the information processing device takes the form of a camera provided with a communication interface to enable connection to a network.

The peripherals connected to the information processing device comprise for example a digital camera 64, or a scanner or any other means of image acquisition or storage, connected to an input/output card (not shown) and supplying multimedia data, for example of video sequence type, to the information processing device.

The device 50 comprises a communication bus 51 to which there are connected:
a central processing unit CPU 52 taking for example the form of a microprocessor;
a read only memory 53 in which may be contained the programs whose execution enables the implementation of the method according to the invention. It may be a flash memory or EEPROM;
A random access memory 54, which, after powering up of the device 50, contains the executable code of the programs of the invention necessary for the implementation of the invention. As this memory 54 is of random access type (RAM), it provides fast accesses compared to the read only memory 53. This RAM memory 54 stores in particular the various images and the various blocks of pixels as the processing is carried out (transform, quantization, storage of the reference images) on the video sequences;
a screen 55 for displaying data, in particular video and/or serving as a graphical interface with the user, who may thus interact with the programs according to the invention, using a keyboard 56 or any other means such as a pointing device, for example a mouse 57 or an optical stylus;
a hard disk 58 or a storage memory, such as a memory of compact flash type, able to contain the programs of the invention as well as data used or produced on implementation of the invention;
an optional diskette drive 59, or another reader for a removable data carrier, adapted to receive a diskette 63 and to read/write thereon data processed or to process in accordance with the invention; and
a communication interface 60 connected to the telecommunications network 61, the interface 60 being adapted to transmit and receive data.

In the case of audio data, the device 50 is preferably equipped with an input/output card (not shown) which is connected to a microphone 62.

The communication bus 51 permits communication and interoperability between the different elements included in the device 50 or connected to it. The representation of the bus 51 is non-limiting and, in particular, the central processing unit 52 unit may communicate instructions to any element of the device 50 directly or by means of another element of the device 50.

The diskettes 63 can be replaced by any information carrier such as a compact disc (CD-ROM) rewritable or not, a ZIP disk or a memory card. Generally, an information storage means, which can be read by a micro-computer or microprocessor, integrated or not into the device for processing (coding or decoding) a video sequence, and which may possibly be removable, is adapted to store one or more programs whose execution permits the implementation of the method according to the invention.

The executable code enabling the video sequence processing device to implement the invention may equally well be stored in read only memory 53, on the hard disk 58 or on a removable digital medium such as a diskette 63 as described earlier. According to a variant, the executable code of the programs is received by the intermediary of the telecommunications network 61, via the interface 60, to be stored in one of the storage means of the device 50 (such as the hard disk 58) before being executed.

The central processing unit 52 controls and directs the execution of the instructions or portions of software code of the program or programs of the invention, the instructions or portions of software code being stored in one of the aforementioned storage means. On powering up of the device 50, the program or programs which are stored in a non-volatile memory, for example the hard disk 58 or the read only memory 53, are transferred into the random-access memory 54, which then contains the executable code of the program or programs of the invention, as well as registers for storing the variables and parameters necessary for implementation of the invention.

It will also be noted that the device implementing the invention or incorporating it may be implemented in the form of a programmed apparatus. For example, such a device may then contain the code of the computer program(s) in a fixed form in an application specific integrated circuit (ASIC).

The device described here and, particularly, the central processing unit 52, may implement all or part of the processing operations described in relation with FIGS. 4 to 14, to implement the methods of the present invention and constitute the devices of the present invention.

The preceding examples are only embodiments of the invention which is not limited thereto.

In particular, the embodiments described above principally envisage the generation of “second” reference images for which only a pair (coefficient number; quantization offset) is different in relation to the “conventional” reference image. It may, however, be envisaged that a larger number of parameters be modified to generate a “second” reconstruction: for example, several pairs (coefficient; offset).

1. Processing method of a video sequence composed of a series of digital images comprising a current image to be processed, said images comprising blocks of data, characterized in that it comprises the steps of:
generating a plurality of different reconstructions of at least the same first image in the sequence, so as to obtain a respective plurality of reference images;
predicting a plurality of blocks of said current image, each from one of said reference images; and
processing jointly, for at least two blocks spatially close in the current image and predicted from the same reference image, prediction information relating to this reference image.

2. Method according to claim 1, in which the prediction information is coded into or decoded from a portion of bit stream which precedes a following portion comprising useful data coding the set of blocks of the current image.

3. Method according to claim 2, in which no identification of said reference images is inserted into said following portion of useful data.

4. Method according to claim 1, comprising forming a tree structure representing a subdivision of the current image into spatial zones, each spatial zone comprising solely blocks which, when they are temporally predicted, are predicted from the same reference image, and the tree structure comprises, associated with each thus defined spatial zone, the prediction information relating to this reference image.

5. Method according to claim 4, in which the tree structure is a quadtree representing a recursive subdivision of the current image into quadrants and sub-quadrants corresponding to said spatial zones.

6. Method according to claim 4, in which an index is associated with each reconstruction of the first image, and the quadtree comprises leaves each corresponding to a spatial zone in the final subdivision, and each leaf is associated with the index corresponding to the reconstruction producing the reference image used in the predictions of blocks of said spatial zone.

7. Method according to claim 4, in which the tree structure is included in a portion of bit stream corresponding to said coded current image, said portion comprising three sub-portions:
a first sub-portion corresponding to the tree structure of the quadtree representing the subdivision of the current image;
a second sub-portion comprising said prediction information relating to all the reference images used for predicting the blocks of the current image; and
a third sub-portion indicating the location, in the second sub-portion, of the prediction information relating to the reference image used for each spatial zone.

8. Method according to claim 7, in which the third sub-portion comprises at least two indications which are relative to two distinct spatial zones and which indicate the same location of prediction information in said second sub-portion.

9. Method according to claim 7, in which the first sub-portion corresponds to the tree structure of the quadtree according to a scan in the order of increasing subdivision levels.

10. Method according to claim 1, in which the current image is subdivided into spatial zones, each spatial zone comprising solely blocks which, when temporally predicted, are predicted from the same reference image, and the method comprising a step for grouping a plurality of spatial zones corresponding to at least two different reference images in a single spatial zone corresponding to a single reference image.

11. Method according to claim 10, in which said grouping comprises a step for modifying the temporal prediction of the temporally predicted blocks that initially constitute one of the grouped spatial zones, such that these blocks are temporally predicted from said single reference image.

12. Method according to claim 1, in which the plurality of reconstructions from at least the same first image is generated using a respective plurality of different reconstruction parameters, and the prediction information relating to a reference image comprises the reconstruction parameters corresponding to this reference image.

13. Method according to claim 12, in which said reconstructions comprise an inverse quantization operation on coefficient blocks, and the reconstruction parameters comprise a number of block coefficients modified in relation to a reference reconstruction, an index of each modified block coefficient and a quantization offset associated with each modified block coefficient.

14. Method according to claim 1, in which the blocks of the current image are only predicted in reference to reconstructions of a single first image, and the prediction information is devoid of information identifying the single first image.

15. Processing device of a video sequence composed of a series of digital images comprising a current image to be processed, said images comprising blocks of data, characterized in that it comprises:
a generation means for generating a plurality of different reconstructions of at least the same first image in the sequence, in order to obtain a respective plurality of reference images;
a prediction means for predicting a plurality of blocks of the current image, each from one of the reference images; and
a processing means to jointly process, for at least two blocks spatially close in the current image and predicted from the same reference image, prediction information relating to this reference image.

16. Device according to claim 15, comprising a quadtree representing a recursive subdivision of the current image into quadrants and sub-quadrants, each quadrant or sub-quadrant comprising solely spatially close blocks which, when they are temporally predicted, are predicted from the same reference image, and
the quadtree comprises, associated with each quadrant and sub-quadrant, the prediction information relating to this reference image used.

17. Data structure coding a video sequence composed of a series of digital images, the structure comprising:
useful data corresponding to data coding blocks of a first image by prediction from reference images, several reference images corresponding to several reconstructions of the same other image, and
a tree structure representing a subdivision of said first image into spatial zones, each grouping one or several blocks spatially close in the first image and predicted from the same reference image; and
wherein the tree structure associates, with each spatial zone, prediction information relating to this same reference image.

18. Data structure according to claim 17, in which the tree structure is a quadtree representing a recursive subdivision of an image into quadrants and sub-quadrants corresponding to said spatial zones, whose leaves are associated with the prediction information.

19. Data structure according to claim 17, comprising, within a bit stream, a plurality of frames each corresponding to an image of a video sequence, each frame comprising, successively, a first header portion comprising the tree structure associated with the image corresponding to the frame and a second portion comprising the useful data associated with said image.

20. Data structure according to claim 19, in which the first portion comprises:
a first sub-portion corresponding to the tree structure of the quadtree representing the subdivision of the current image;
a second sub-portion comprising the prediction information relating to all the reference images used for predicting the blocks of the image; and
a third sub-portion indicating the location, in the second sub-portion, of the prediction information relating to the reference image used for each spatial zone.

21. Information storage means, possibly totally or partially removable, readable by a data processing system, comprising instructions for a data processing program configured to implement the processing method of claim 1, when the program is loaded and executed by the data processing system.

22. Computer program product readable by a microprocessor, comprising portions of software code configured to implement the processing method of claim 1, when it is loaded and executed by the microprocessor.
